(19) United States
(12) Patent Application Publication
(10) Pub. No.: US 2016/0259501 A1
(43) Pub. Date: Sep. 8, 2016

(54) Computer System and Method for Dynamically Adapting User Experiences

(71) Applicant: Aptify Corporation, Tysons Corner, VA (US)

(72) Inventors: Amith Nagarajan, New Orleans, LA (US); Robert Kihm, Sacramento, CA (US)

(73) Assignee: Aptify Corporation, Tysons Corner, VA (US)

(21) Appl. No.: 15/057,395

(22) Filed: Mar. 1, 2016

Related U.S. Application Data
(60) Provisional application No. 62/126,926, filed on Mar. 2, 2015.

(51) Int. Cl. G06F 3/0482; G06F 3/0484

(52) U.S. Cl. CPC G06F 3/0482; G06F 3/04842

(57) ABSTRACT

To increase processing efficiency, a computer system receives a plurality of inputs from a user into an application at a plurality of times. The system also receives data representing a plurality of states of the application at the plurality of times. Correspondences between the plurality of inputs and the plurality of states are identified based on the plurality of times. The system adapts elements of a user interface of the application based on the identified correspondences between the plurality of inputs and the plurality of states.

### BACKGROUND

As computer system applications have advanced, the amount of content output to a user and the functionality of the applications available to the user have increased. While an application may include content and functionality that may be desirable to a user community as a whole, a particular user may interact with less than all of the available content and functionality of the application. Further, the same particular user may interact with certain available content and functionality in one instance and other content and functionality in another instance.

There have been attempts to modify user experiences (including interface modification such as layout and screen contrast, and content modification) based on the user (e.g., age, size of fingers, inferred expertise), models of the user, the user's tasks, work, goals, tracked interactions (e.g., input), device type (e.g., screen size), and environmental conditions (e.g., ambient light). There have also been attempts to track user interaction to determine when a user should be prompted with help, and also to help improve speed in data entry (e.g., adaptive dynamic keyboards). However, even with these attempts, presentation of content and functionality to users remains less than optimal and often involves wasted computer system resources such as processor operations.

What is needed, therefore, are improved systems and methods for dynamically adapting user experiences.

### SUMMARY

To increase processing efficiency, a computer system receives a plurality of inputs from a user into an application at a plurality of times. The system also receives data representing a plurality of states of the application at the plurality of times. Correspondences between the plurality of inputs and the plurality of states are identified based on the plurality of times. The system adapts elements of a user interface of the application based on the identified correspondences between the plurality of inputs and the plurality of states.

Other features and advantages of various aspects and embodiments of the present invention will become apparent from the following description and from the claims.

### BRIEF DESCRIPTION OF THE DRAWINGS

FIG. 1 is a dataflow diagram of a system for adapting a user's experience when using a computer system according to one embodiment of the present invention;

FIG. 2 is a flowchart of a method performed by the system of FIG. 1 according to one embodiment of the present invention;

FIG. 3 is a schematic representation of an application screen representing the output provided by the user interface of FIG. 1 according to one embodiment of the present invention; and

FIG. 4 is a schematic representation of the application screen of FIG. 3 including modified elements provided by the user interface of FIG. 1 according to one embodiment of the present invention.

### DETAILED DESCRIPTION

As discussed herein, applications have advanced such that the amount of content output to users and the functionality of the applications have increased. A particular user may interact with less than all available content and functionality of an application. Further, the same particular user may interact with certain available content and functionality in one instance and other content and functionality in another instance.

Consider the following examples that are intended merely to be illustrative and not to impose limitations. A first employee user having a particular job (e.g., sales associate) may use certain content and functionality of an application to accomplish tasks related to their job (e.g., daily tasks), while a second employee user having a different job (e.g., manager) may use partially or entirely different content and functionality to accomplish job tasks (e.g., human resource functions). Similarly, the first employee user may use different content and functionality to accomplish tasks related to another aspect of their job (e.g., mid-month sales reports instead of daily tasks). The first employee user may use different content and functionality even to accomplish a same set of job tasks based simply on a changed approach to using the same software application (e.g., a faster way to run a specific report).

In each of these examples, the particular content and functionality that a particular user desires to interact with may be grouped as, for example, behaviors of the user (e.g., daily tasks, monthly reports, human resource functions), and non-behavioral characteristics of the user (e.g., sales associate employee profile, manager relationship relative to other employees, location).

Embodiments of the present invention are directed to computer-based systems and methods for adapting a user's experience when using a computer system thereby reducing wasted processor operations and increasing processing efficiency. For example, a system may receive a plurality of inputs from a user into an application at a plurality of times. The system also may receive data representing a plurality of states of the application at the plurality of times. Correspondences between the plurality of inputs and the plurality of states may be identified based on the plurality of times. The system may adapt elements of a user interface of the application based on the identified correspondences between the plurality of inputs and the plurality of states. In this way, inferences may be drawn by the computer system and the adapting of elements may be based on the inferences (identified correspondences). The inferences may be drawn from any one or more of: (1) historical behavior of the user, (2) non-behavioral characteristics of the user (such as the user's role and/or other information stored in one or more profiles of the user); (3) historical behavior of other users; and (4) non-behavioral characteristics of other users (such as the roles of such users and/or other information stored in one or more profiles of the other users).

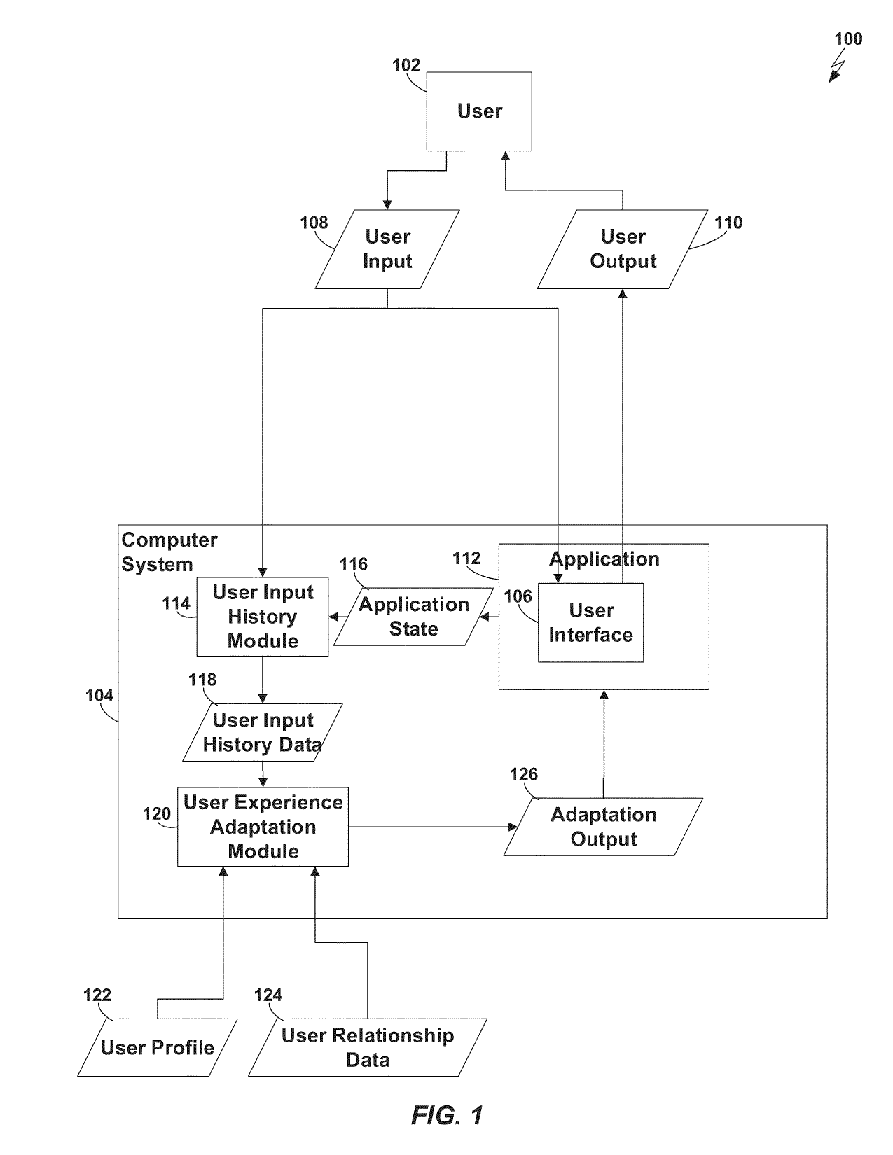

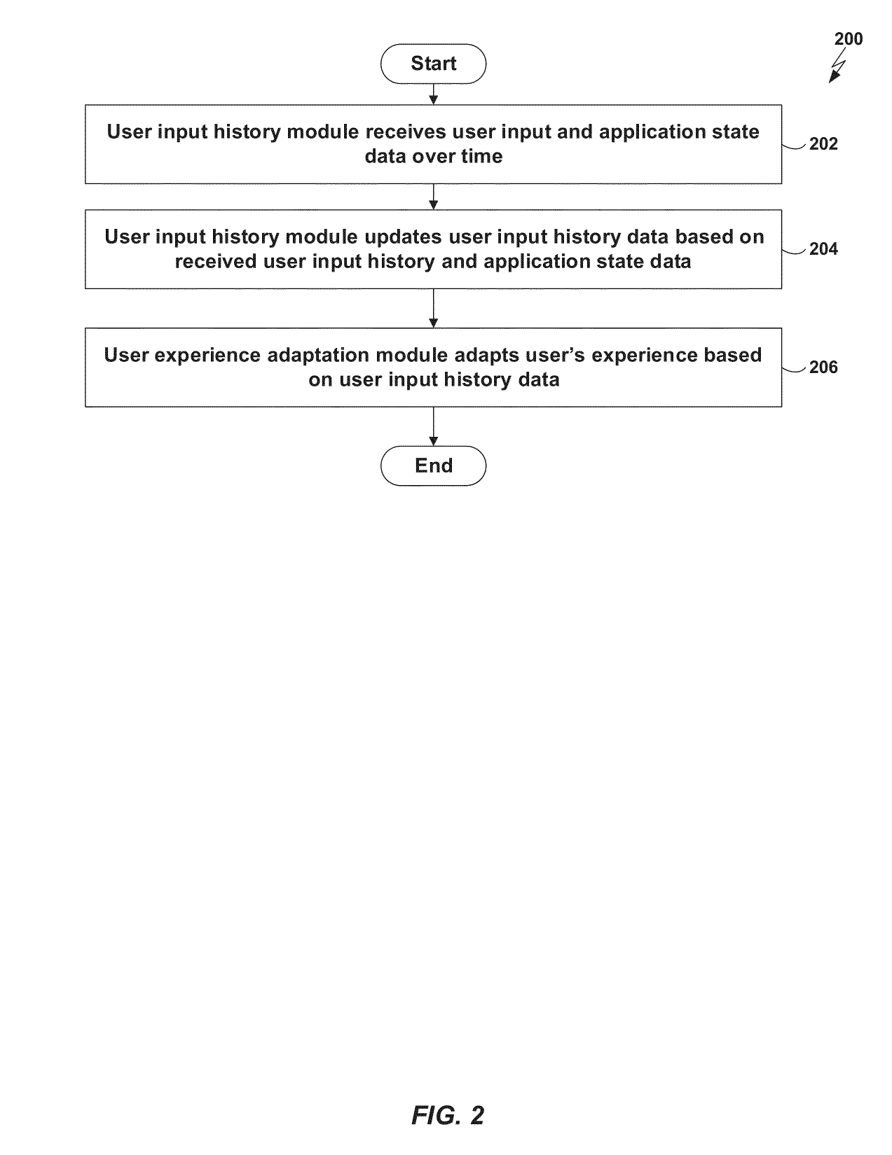

Referring now to FIG. 1, a dataflow diagram is shown of a computer-based system 100 for adapting a user 102's experience when using a computer system 104 according to one embodiment of the present invention. Referring to FIG. 2, a flowchart is shown of a method 200 performed by the system 100 of FIG. 1 according to one embodiment of the present invention.

The computer system 104 may be or include any type of computing device(s), such as one or more computing devices of each of one or more of the following types, in any combination: server computer desktop computer, laptop computer, tablet computer, smartphone, and wearable computing device (such as smart watch, smart glasses, and augmented reality device).

The computer system 104 may include one or more user interfaces, such as the user interface 106. The user 102 may provide input 108 to the user interface 106. The input 108 may include any type of input, such as textual input, selection input (e.g., selection of one or more user interface elements), graphical input, video input, audio (e.g., speech) input, and touch input, provided via one or more input components, such as a keyboard, mouse, trackpad, touchscreen, microphone, or any combination thereof. Such input components may be part of (i.e., contained within) the computer system 104 and/or connected to (e.g., by wired and/or wireless connections) the computer system 104.

The user interface 106 may provide output 110 to the user 102. The output 108 may include any type of output, such as textual output, graphical output, tactile output (such as vibration of a smartphone or other computing device), video output, and audio (e.g., recorded or emulated speech) output, in any combination. The user interface 106 may provide the output 110 to the user 102 via one or more output components, such as a monitor, touchscreen, speaker, printer, or any combination thereof. Such output components may be part of (i.e., contained within) the computer system 104 and/or connected to (e.g., by wired and/or wireless connections) the computer system 104.

Although only one user interface 106 is shown in FIG. 1 for ease of illustration, the computer system 104 may include more than one user interface. Any reference herein to the user interface 106, therefore, should be understood to refer to one or more user interfaces. Furthermore, as will be described in more detail below, the system 100 and method 200 may adapt (modify) the user interface 106. As a result, the user interface 106 shown in FIG. 1 may be dynamic, rather than static.

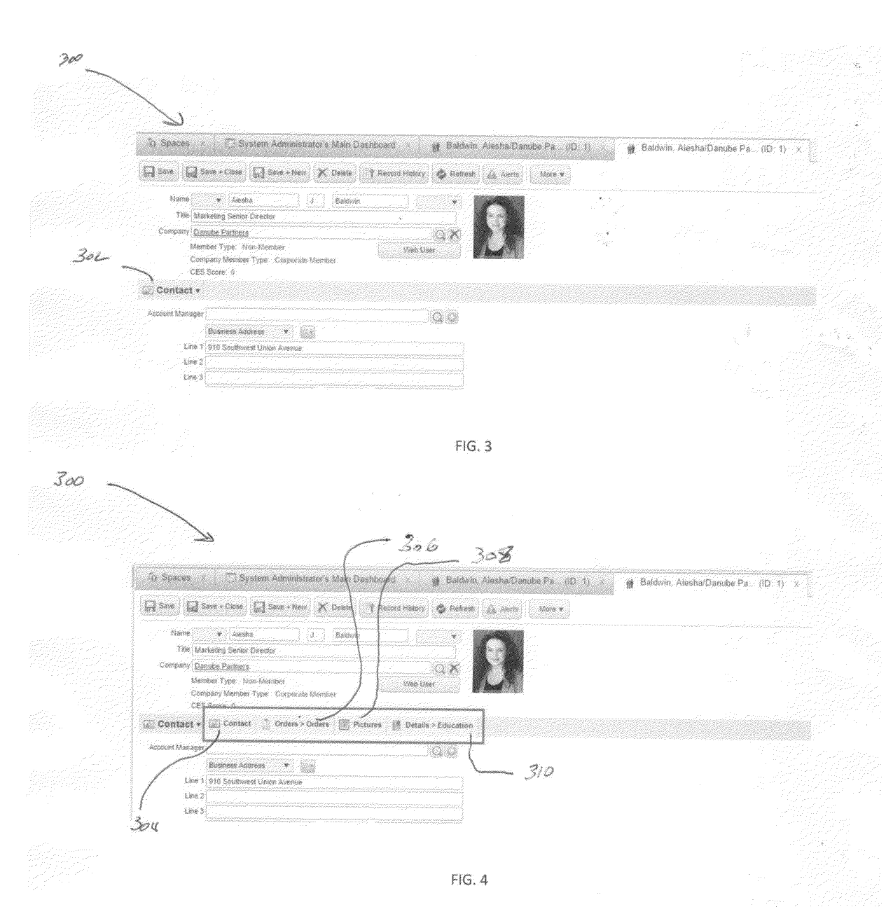

For example, the user interface 106 may be or include one or more graphical user interfaces which may include any type(s) of graphical user interface elements in any combination, such as any combination of text, images, audio, video, tabs, text fields, checkboxes, buttons, radio buttons, dropdown lists, menus, menu items, windows, dialog boxes, dashboards, and reports. The output 110 that the user interface 106 provides to the user 102 may include output representing such user interface elements. For example, the output 110 may include graphical output representing an application screen (such as that shown in FIG. 3) containing a particular combination of graphical user interface elements (e.g., text, images, tabs, buttons, dropdown lists, and menu items). As another example, the output 110 may include graphical output representing a web page containing a particular combination of text, images, and text fields. As with other elements described herein, features from one embodiment may be combined with features from another. Accordingly, in another embodiment, a Web-based application may be provided containing similar or other graphical user interface elements.

As will be described in more detail below, the system 100 and method 200 may modify one or more elements (e.g., graphical user interface elements) of the user interface 106, which may thereby cause the system 100 to modify the output 110 provided by the user interface 106 to the user 102 to reflect the modifications to the user interface elements. For example, the system 100 and method 200 may remove a user interface element (e.g., menu item) from the user interface 106, in response to which the user interface 106 may remove a graphical representation of the menu item from the output 110 provided to the user 102, so that the removed menu item is not visible to the user 102. As another example, the system 100 and method may reorder items in a list in the user interface 106, in response to which the user interface 106 may provide output 110 representing the reordered list to the user 102. As yet another example, the system 100 and method 200 may add a user interface element (e.g., menu item) to the user interface 106, in response to which the user interface 106 may provide output 110 representing the added user interface element to the user 102.

The user interface 106 may be part of, and provided by, one or more software applications, such as application 112. As one example, the application 112 may be installed on the computer system 104, and the user 102 may execute the application 112 on the computer system 104 locally, i.e., by accessing the computer system 104 directly via input and output devices that are not connected to the computer system 104 over the Internet or other network. As another example, the application 112 may be a network application, such as an Internet-based or Web-based application, in which case the user 102 may access the computer system 104 over a network, such as the Internet, and in which case the user 102 may provide the input 108 to the computer system 104 over the network (e.g., Internet), and in which case the user interface 106 may provide the output 110 to the user 102 over the network (e.g., Internet).

As yet another example, an application may be a network application installed at a remote computer, such as a Web server (not shown in FIG. 1), in which case the user 102 may access the application over a network (e.g., Internet) via the computer system 104, such as by using a web browser installed on the computer system 104. In this case, application 112 installed on the local computer 104 may be the web browser, and the user interface 106 may be a user interface 106 of the remote application, but provided by the web browser installed on the (local) computer system 104 on behalf of the remote computer. For example, if the remote application is a Web-based application, the computer system 104 may access the remote application via a Web browser (which plays the role of the application 112 in FIG. 1) installed on the computer system 104, in which case the computer system 104 may use the web browser 112 to provide the user interface 106 of the remote application to the user 102 on behalf of the remote computer. Many other configurations are well-known to those having ordinary skill in the art and are within the scope of the present description.

In general, the system 100 and method 200 may customize the user interface 106, such as by customizing the output 110 provided by the user interface 106 to the user 102, based on, for example, inferences drawn by the system 100 and method 200 from one or both of: (1) historical behavior of the user 102 (such as historical interactions of the user 102 with the computer system 104 and/or with other users), and (2) non-behavioral characteristics of the user 102, such as characteristics indicated by one or more profiles of the user 102 and one or more relationships of the user 102 with other users.

The computer system 104 may include a user input history module 114, which may receive as input one or both of: (1) one or more inputs 108 provided by the user 102 to the computer system 104 (e.g., to the user interface 106 of the application 112) over time; and (2) application state data 116 received from the application (FIG. 2, operation 202). The user input history module 114 generates and/or updates user input history data 118 based on the received user input 108 and application state data 116 (FIG. 2, operation 204).

The user input history module 114 may receive any or all of the user input 108 provided by the user 102 to the application 112, and generate the user input history data 118 based on any or all such user input 108. Although the user input history module 114 is shown in FIG. 1 as receiving the user input 108 directly from the user 102, additionally or alternatively the user input history module 114 may receive some or all of the user input 108 from another source, such as the application 112, possibly after processing such input 108 into another form.

The user input 108 received by the user input history module 114 may include, for example, data representing text inputted by the user 102 into the user interface 106, selections of user interface elements in the user interface 106 by the user 102 (e.g., mouse clicks, taps on a touch screen), and other interactions with user interface elements in the user interface 106 (such as moving, deleting, adding, or modifying such user interface elements). The user input 108 may be inputted by the user 102 using any of a variety of input modes, such as keyboard input, mouse input, trackpad input, touchscreen input (e.g., gesture-based input such as taps or swipes), and speech input. Any of the forms of user input 108 disclosed herein may be provided by the user 102, and received by the user interface 106, using any one or more of such modes, which are merely examples and not limitations of modes that may be used to provide and receive the user input 108.

The application state data 116 may include any data representing the state of the application 112 (e.g., the user interface 106) and/or elements of the computer system 104 outside of the application 112 at any time(s). For example, the application state data 116 may include data representing a state of the application (e.g., the user interface 106) at a time corresponding to an input within the user input 108. For example, if the user input 108 includes data representing a click on a menu item in the user interface 106, the application state 116 may include data representing the text of the menu item at the time the user 102 clicked on that menu item.

The user input history module 114 may store any of a variety of data in the user input history data 118, including some or all of the user input 108, some or all of the application state 116, any data derived therefrom, and any combination thereof. For example, the user input history module 114 may store any of the following data obtained and/or derived from the user input 108, in any combination:
data representing the physical input provided by the user 102, e.g., keyboard key pressed, mouse click, touch screen tap and coordinates;
data representing a low-level logical input provided by the user 102, e.g., character(s) input, mouse click coordinates;
data representing a high-level logical input provided by the user, e.g., an identifier of a user interface element selected or otherwise interacted with, data representing an action performed on that user interface element (e.g., select, move, add, delete, modify);
data representing a time at which the input was provided;
data representing a computer, application, and/or user interface into which the input was provided;
data representing an identity of the user 102 who provided the input.

Since the user input 108 may include data representing one or more inputs provided by the user 102 over time, the user input history module 114 may store any of the above data for each of one or more such inputs in the user input history data 118.

The user input history module 114 may store any of the following data obtained and/or derived from the application state data 116, in any combination:
data representing a state of the user interface 106, such as data representing identities and/or properties of user interface elements in the user interface 106;
data representing an identity and/or properties of the computer system 104;
data representing an identity and/or properties of the application 112;
data representing one or more times associated with the data above, such as on or more times at which the user interface 106 was observed or otherwise known to have particular properties.

Each of one or more user inputs 108 may have been provided while the application 112 (e.g., the user interface 106) was in a certain state. For example, the user input 108 may include a mouse click on a menu item in the user interface 106 while the application 112 was displaying a particular dialog box, and the user input 108 may include text input which the user 102 provided while the user interface 106 was displaying a particular window. The user input history module 114 may identify correspondences between particular inputs in the user input 108 and their corresponding application states in the application state data 116. A particular user input may “correspond” to a particular application state if, for example, the user input was provided by the user 102 to the application 112, while the application 112 was in that particular application state.

The user input history module 114 may identify such correspondence between particular inputs in the user input 108 and particular states in the application state data 116 in any of a variety of ways. For example, as the user input history module 114 receives new user inputs in the user input 108 and new application states in the application state 116, the user input history module 114 may determine that the current (e.g., most recently-received) user input corresponds to the current (e.g., most recently-received) application state. As another example, the user inputs 108 may include timestamps or other unique identifiers, and the application states 116 may include timestamps or other unique identifiers. The user input history module 114 may correlate the identifiers in the user inputs 108 with the identifiers in the application state data 116 to identify particular user inputs which correspond to particular application states 116. For example, the user input history module 114 may conclude that a particular user input corresponds to a particular application state if the timestamps associated with the particular user input and the particular application state differ from each other by no more than some predetermined maximum threshold amount (e.g., 1 millisecond, 1 second, or 10 seconds).

The user input history module 114 may store, in the user input history data 118, data indicating the correspondences between particular inputs in the user input 108 and particular states in the application state 116. For example, the user input history module 114 may store data indicating that a first user input in the user input history data 118 corresponds to a first application state in the application state data 116, data indicating that a second user input in the user input history data 118 corresponds to a second application state in the application state data 116, and so on.

The system 100 may also include a user experience adaptation module 120, which may adapt the user 102's experience with the computer system 104 based on the user 102's past behavior, such as based on the user input history data 118 (FIG. 2, operation 206). As this implies, the user experience adaptation module 120 may adapt the user 102's experience based on, for example, any combination of one or more of the following: the user input 108, the user output 110, and the application state data 116.

The term “user experience,” as used herein, includes, for example, content that the computer system 104 (e.g., the user interface 106 of the application 112) outputs to the user 102 and functionality of the application 112 (e.g., of the user interface 106 of the application 112). The adaptation performed by the user experience adaptation module 120 may, therefore, include either or both of:
adapting content in the user interface 106, such as by adding content to, removing content from, modifying content within, changing the location of content in, and changing the size, color, or formatting of elements in the user interface 106, and thereby causing corresponding changes in the user output 110 reflecting such adaptations to the user interface 106; and
adapting functionality of the application 112, such as by modifying actions performed by the application 112 in response to input 108 provided by the user.

The user experience adaptation module 120 may, therefore, adapt the user 102's experience by providing adaptation output 126 to the application 112. The adaptation output 126 may, for example, include instructions to the application 112 for modifying the user interface 106 in particular ways.

Although the user experience adaptation module 120 is described above as adapting the user 102's experience based on the user input history data 118, the user experience adaptation module 120 may adapt the user 102's experience based on other data, either instead of or in addition to the user input history data 118. For example, the user experience adaptation module 120 may adapt the user 102's experience based on any combination of any one or more of: the user input history data 118, one or more profiles 122 of the user, and user relationship data 124.

The user profile data 122 may, for example, include and/or be derived from one or more profiles of the user 102, such as one or more profiles of the user 102 in a corporate database and/or on social networking sites, such as Facebook, Twitter, and LinkedIn. Such profiles may include data representing any of a variety of information about the user 102, such as a unique identifier of the user (e.g., the user's login ID on the social networking site), the user 102's real name, email address, telephone number, profession, role, and title.

The user relationship data 124 may include any of a variety of data representing information about the user 102. For example, the user relationship data 124 may include any one or more of the following, in any combination:
data representing relationships of the user 102 with other people, such as data representing connections of the user 102 with other uses on one or more social networking sites;
data representing communications between the user 102 and other people, such as data representing messages sent and received by the user 102 via email, text message, and social networking sites;
data representing one or more organizational roles of the user 102, such as the user 102's job role, title, and/or position within the hierarchy of an organization;
data representing relationships between the user 102 and other people within the hierarchy of the organization (such as data indicating that the user 102 is a supervisor of another specified person and data indicating that the user 102 is a subordinate of another specified person), and data representing strengths of such relationships;
data representing interactions between the user 102 and other people within the organization.

As indicated above, the user relationship data 124 may include data representing the strength of one or more relationships between the user 102 and other users. The computer system 104 may generate such data in any of a variety of ways. For example, the computer system 104 may observe the number of interactions between the user 102 and another user, and generate data indicating that the strength of the relationship between the user 102 and the other user is proportional to, or otherwise based on, the number of interactions between the two users. As another example, the computer system 104 may generate data indicating that the user 102 has a stronger relationship with a user having the same role as the user 102 than with a user having a different role than the user 102. As yet another example, the computer system may generate data indicating that the user 102 has a stronger relationship with a user who interacts with the same data records in the computer system 104 as the user 102 than with a user who does not interact with the same data records as the user 102.

The user experience adaption module 120 may identify patterns within the user input history data 118, the user profile 122, and/or the user relationship data 124. For example, the user experience adaptation module 120 may draw inferences from any such data about behaviors in which the user 102 commonly engages with the application 112. As another example, the user experience adaptation module 120 may draw inferences from any such data about people with whom the user 102 is related. For example, the user experience adaptation module 120 may draw such inferences from communications in which the user 102 and other people engage. As a particular example, the user experience adaptation module 120 may conclude that the user 102 is a supervisor of another person based on observing that the other person regularly seeks approval from the user 102 before sending documents to customers.

A specific example of an adaptation that the user experience adaptation module 120 may perform is now discussed with respect to FIGS. 3 and 4. This example, and the additional examples that follow, are intended merely to be illustrative and to aid in the in the understanding of certain embodiments of the system 100 and method 200, and not to impose limitations thereon.

FIG. 3 is a schematic representation of an application screen representing the output provided by the user interface of FIG. 1 according to one embodiment of the present invention. FIG. 4 is a schematic representation of the application screen of FIG. 3 including modified elements provided by the user interface of FIG. 1 according to one embodiment of the present invention.

The user 102 in the example of FIGS. 3 and 4 may work with corporate members of an association. The user 102 may view contact details for an individual affiliated with (e.g., employed by) the association. For example, in reviewing a corporate member in an association, the user 102 may open a general contact record for the individual. A user interface 106 of the system 100 may output as user output 110 a graphical output representing a contact record 300. The graphical output representing the contact record 300 may include a number of graphical user interface elements, including, e.g., a graphical picture of the individual, a text box containing text indicating a name of the individual, and the like.

The graphical output representing the contact record 300 may include a “contact” menu button element 302. By selecting the contact menu button element 302, a dropdown menu (not shown) may appear containing a number of options. Though the dropdown menu may include many options, the user 102 may have a pattern of interacting with a few of these many options.

The system 100 may observe the user's behavior, as described above, in connection with multiple general contact records. Based on such observations, the system 100 may identify the pattern of behaviors described above. The system may conclude, based on the identified behavior pattern, that the user 102 primarily interacts with certain options, including, e.g., an option to contact the individual, an option to view orders from the individual, an option to view photos of the individual, and an option to view details about the individual (such as, e.g., educational details regarding the individual). In response to drawing this conclusion, the system 100 (e.g., user experience adaption module 120) may, for example, modify the user interface 106 so that the user interface adds to the user output 110, graphical user interface elements related to the option to contact the individual, the option to view orders from the individual, the option to view photos of the individual, and the option to view details about the individual (such as, e.g., educational details regarding the individual). For example, as shown in FIG. 4, the user interface may add a “contact” button element 304 that when selected, displays the individual's contact information. Additionally, the user interface may add an “orders” button element 306 that when selected runs and displays a report of all orders by the individual, a “pictures” button element that when selected displays all photographs the system 100 has of the individual, and an “education” button element that when selected displays educational details of the individual. This is one example of adapting the user interface 106 based on the past behavior of the user 102.

Consider the following additional examples of adaptations that the user experience adaptation module 120 may perform. It is again noted that such examples are intended merely to be illustrative and to aid in the understanding of certain embodiments of the system 100 and method 200, and not to impose limitations thereon. The user 102 may be an employee of a company, and may often work with a particular category of prospective customers (such as potential customers from the West Coast of the U.S.). Now assume that the user 102's interactions with prospective customers tend to follow a particular pattern. For example, the user 102's interactions with potential customers may typically follow the following pattern: the user 102 may receive an initial phone call from the prospective customer, return the initial phone call, make followup calls to the prospective customer, and forward phone calls from the prospective customer to other sales representatives if the user 102 determines that the prospective customer is not on the West Coast of the U.S.

The system 100 may observe the user 102's behavior, as described above, in connection with multiple prospective customers. Based on such observations, the system 100 may identify the pattern of behaviors described above. The system 100 may conclude, based on the identified behavior pattern, that the user 102 only (or primarily) interacts with prospective customers from the West Coast of the U.S. In response to drawing this conclusion, the system 100 (e.g., the user experience adaptation module 120) may, for example, modify the user interface 106 so that the user interface 106 filters out information about prospective customers who are not from the West Coast of the U.S. As a result, the user interface 106 may provide, in the user output 110, information about prospective customers who are from the West Coast of the U.S. and not include information about prospective customers who are not from the West Coast of the U.S. This is one example of adapting the user interface 106 based on the past behavior of the user 102.

As another example, the system 100 may observe that the user 102 frequently sends particular documents to prospective customers by manually attaching those documents to the initial email that the user 102 sends to each prospective customer. In response to making this observation, the system 100 (via the user interface 106) may remind the user 102 to send the particular documents to new prospective customers in the future, and/or automatically attach such documents to emails sent by the user 102 to prospective customers. This is one example of adapting the behavior of the application 112 based on the past behavior of the user 102. More generally, the user experience adaptation module 120 may observe that the user 102 always or frequently performs a particular action manually and, in response, the user experience adaptation module 120 may either: (1) suggest that the user 102 perform that action in the future, or (2) perform the action automatically on the user 102's behalf in the future.

As another example, the system 100 may observe that the user 102 typically performs several actions in order to achieve a particular result, such as clicking on a menu, then a menu item, and then a button in order to send a message to a prospective customer. The user experience adaptation module 120 may identify an alternative way to achieve the same result using a smaller number of actions. For example, the system 100 may identify a way to send a message to a prospective customer by clicking on a single button. The system 100 may suggest the alternative, more efficient, action to the user 102.

The system 100 may perform any of the functions disclosed above in connection with multiple users, not only the single user 102. For example, the system 100 may observe the behavior of multiple users (including the user 102) over time. The system 100 may analyze the data gathered about such users and identify a cohort of users who are similar to the user 102, such as users who: (1) have the same or similar organizational role as the user 102 (e.g., sales representative); (2) are within the user 102's social network (e.g., who are connected to the user 102 in a social networking system, such as Facebook or LinkedIn); and/or (3) users who exhibit similar behavior to the user 102 (such as users who respond to inquiries from prospective customers). The system 100 may then perform any of a variety of actions based on the user 102's cohort. For example, the system 100 may adapt the user interface 106 to be the same as or similar to user interfaces used by users in the user 102's cohort. For example, if information about non-West Coast customers is filtered from the user interfaces of users in the user 102's cohort, then then system 100 may suggest to the user 102 that the user 102 adapt the user 102's user interface 106 to filter information about non-West Coast customers, or may automatically perform such filtering.

As the examples above illustrate, the system 100 may adapt the user 102's experience based on inferences drawn by the system 100 from information such as the user 102's organizational role, social network, and/or behavior. Such inferences may be drawn using any of a variety of techniques, such as machine learning or neural networks. In this way, the system 100 is not limited to applying adaptations that are based directly on instructions from the user 102 or a system administrator.

The system 100 may apply any particular adaptation only in certain contexts, such as contexts which are the same as or similar to the context from which the adaptation was derived. For example, if the user experience adaptation module 120 determines that the user 102 always sends reminder emails to prospects on Friday afternoons, the user experience adaptation module 120 may recommend, on Friday afternoons, that the user send reminder emails to prospects. As another example, if the user experience adaptation module 120 determines that the user uses a particular tab in the user interface 106 only during business hours, then the user experience adaptation module 120 may display that tab to the user 102 during business hours but hide that tab outside of business hours. As these examples illustrate, the user experience adaptation module 120 may identify the user 102's current context, compare that context to previously observed contexts, and apply, to the application 112 only those adaptations which were derived from contexts that are the same as or sufficiently similar to the user 102's current context.

Once the user experience adaptation module 120 has applied one or more adaptations to the computer system 104, the user 102 may provide feedback on such adaptations. For example, the user 102 may provide input indicating whether the user 102 likes (i.e., approves of) or dislikes (i.e., disapproves of) a particular adaptation. The user experience adaptation module 120 may receive and store such input, and take such input into account when making further adaptations to the computer system 104. For example, in response to receiving input from the user 102 disapproving of a particular adaptation, the user experience adaptation module 120 may undo that adaptation, such as by removing a filter that was applied as an adaptation.

As another example, the user 102's use or disuse of a particular adaptation may be observed by the user experience adaptation module 120 and interpreted as approval or disapproval, respectively, of the adaptation by the user 102. For example, if the user experience adaptation module 120 applies an adaptation which includes adding a particular user interface element (e.g., tab) to the user interface 106, and the user 102 does not use (e.g., click or tap on) the added user interface element, the user experience adaptation module 120 may interpret such lack of use as disapproval by the user 102 of the added tab. In response, the user experience adaptation module 120 may take any of the actions disclosed herein in response to user disapproval of an adaptation, such as undoing the adaptation (e.g., removing a tab that was added to the user interface 106).

Embodiments of the present invention have a variety of advantages. For example, the system 100 of FIG. 1 automatically adjusts to and learns from the behavior of the user 102 and of other users. By continually learning about the user 102 and other users, the user experience adaptation module 120 can present the user 102 and other users increasingly relevant functionality and data, and also automate many steps that would ordinarily require manual effort. As a result, the user experience adaptation module 120 can make the user 102's experience more relevant to the user 102's goals and preferences, and also enable the user 102 to accomplish tasks more effectively and efficiently.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A computer-implemented method of adapting elements of a user interface of an application to increase processing efficiency, the method comprising:
(A) receiving a plurality of inputs from a user into the application at a plurality of times;
(B) receiving data representing a plurality of states of the application at the plurality of times;
(C) identifying correspondences between the plurality of inputs and the plurality of states based on the plurality of times; and
(D) adapting elements of the user interface of the application based on the identified correspondences between the plurality of inputs and the plurality of states.

2. The computer-implemented method of claim 1,
wherein the plurality of inputs represent high-level logical input provided by the user, and
wherein the plurality of states includes a state of the user interface.

3. The computer-implemented method of claim 2, wherein the adapting of the elements of the user interface includes one or more of adding additional elements, deleting one or more of the elements, and modifying content within one or more of the elements.

4. The computer-implemented method of claim 1,
wherein the plurality of inputs include one or more of an identity of a computer, an identity of an application, and an identity of a user interface element into which input is received.

5. The computer-implemented method of claim 4, wherein the plurality of states represent one or more of a state of the computer, a state of the application, and a state of the user interface element into which input is received.

6. The computer-implemented method of claim 1, wherein (C) comprises identifying correspondences based on one or more of historical behavior of the user and non-behavioral characteristics of the user.

7. The computer-implemented method of claim 1, wherein the elements of the user interface comprise one or more of text, images, audio, video, gestures, tabs, text fields, checkboxes, buttons, radio buttons, dropdown lists, menus, menu items, windows, dialog boxes, dashboards, and reports.

8. The computer-implemented method of claim 1, wherein (C) comprises:
(C1) determining that one of the plurality of inputs corresponds to one of the plurality of states if both differ from one of the plurality of times by no more than a predetermined threshold.

9. The computer-implemented method of claim 1, wherein (C) comprises:
(C1) determining that one of the plurality of inputs received during one of the plurality of states corresponds to said one of the plurality of states.

10. The computer-implemented method of claim 1, wherein (C) comprises:
(C1) determining that a most recent of the plurality of inputs corresponds to a most recent of the plurality of states.

11. The computer-implemented method of claim 1, wherein (C) comprises:
(C1) comparing an identifier of one of the plurality of inputs with an identifier of one of the plurality of states; and
(C2) determining that said one of the plurality of inputs and said one of the plurality of states correspond based on a result of (C1).

12. A non-transitory computer readable medium comprising computer program instructions executable by a computer processor to perform a method, comprising:
(A) receiving a plurality of inputs from a user into the application at a plurality of times;
(B) receiving data representing a plurality of states of the application at the plurality of times;
(C) identifying correspondences between the plurality of inputs and the plurality of states based on the plurality of times; and
(D) adapting elements of the user interface of the application based on the identified correspondences between the plurality of inputs and the plurality of states.

13. The computer readable medium of claim 12,
wherein the plurality of inputs represent high-level logical input provided by the user, and
wherein the plurality of states includes a state of the user interface.

14. The computer readable medium of claim 13, wherein the adapting of the elements of the user interface includes one or more of adding additional elements, deleting one or more of the elements, and modifying content within one or more of the elements.

15. The computer readable medium of claim 12,
wherein the plurality of inputs include one or more of an identity of a computer, an identity of an application, and an identity of a user interface element into which input is received.

16. The computer readable medium of claim 15, wherein the plurality of states represent one or more of a state of the computer, a state of the application, and a state of the user interface element into which input is received.

17. The computer readable medium of claim 12, wherein (C) comprises identifying correspondences based on one or more of historical behavior of the user and non-behavioral characteristics of the user.

18. The computer readable medium of claim 12, wherein the elements of the user interface comprise one or more of text, images, audio, video, tabs, text fields, checkboxes, buttons, radio buttons, dropdown lists, menus, menu items, windows, dialog boxes, dashboards, and reports.

19. The computer readable medium of claim 12, wherein (C) comprises:
(C1) determining that one of the plurality of inputs corresponds to one of the plurality of states if both differ from one of the plurality of times by no more than a predetermined threshold.

20. The computer readable medium of claim 12, wherein (C) comprises:
(C1) determining that one of the plurality of inputs received during one of the plurality of states corresponds to said one of the plurality of states.

21. The computer readable medium of claim 12, wherein (C) comprises:
(C1) determining that a most recent of the plurality of inputs corresponds to a most recent of the plurality of states.

22. The computer readable medium of claim 12, wherein (C) comprises:
(C1) comparing an identifier of one of the plurality of inputs with an identifier of one of the plurality of states; and
(C2) determining that said one of the plurality of inputs and said one of the plurality of states correspond based on a result of (C1).
